(19) United States
(12) Patent Application Publication
(10) Pub. No.: US 2026/0143364 A1
(43) Pub. Date: May 21, 2026

(54) IN-VEHICLE DEVICE

(71) Applicant: TOYOTA JIDOSHA KABUSHIKI KAISHA, Toyota-shi (JP)

(72) Inventors: Noriaki ITO, Toyota-shi (JP); Shingo SUGIMOTO, Nagoya-shi (JP); Yuma ITO, Chiryu-shi (JP)

(73) Assignee: TOYOTA JIDOSHA KABUSHIKI KAISHA, Toyota-shi (JP)

(21) Appl. No.: 19/328,716

(22) Filed: Sep. 15, 2025

(30) Foreign Application Priority Data
Nov. 19, 2024 (JP) 2024-201903

(51) Int. Cl. H04W 24/04

(52) U.S. Cl. CPC H04W 24/04

(57) ABSTRACT

An in-vehicle device includes a communication unit that is able to perform communication by any of mobile object communication lines, and a controller that causes the communication unit to switch to a second line in a case where a communication failure occurs during communication via a first line and that causes the communication unit to switch from the second line to the first line in a case where the communication failure is resolved. The controller causes the communication unit to maintain communication via the second line until after a lapse of a predetermined period in a case where an event in which the communication via the second line is to be maintained occurs even in a case where the communication failure has been resolved.

### CROSS-REFERENCE TO RELATED APPLICATION

This application claims priority to Japanese Patent Application No. 2024-201903 filed on November 19, 2024. The disclosure of the above-identified application, including the specification, drawings, and claims, is incorporated by reference herein in its entirety.

### BACKGROUND

### 1. Technical Field

The present disclosure relates to an in-vehicle device.

### 2. Description of Related Art

A technique of appropriately switching a plurality of communication lines such as mobile object communication is known. For example, Japanese Unexamined Patent Application Publication No. 2024-123687 (JP 2024-123687 A) discloses a technique of switching a main line and a backup line to each other in accordance with recovery from a failure during occurrence of a failure in the main line.

### SUMMARY

In a technique of executing switching of communication lines, there is room for improving smoothness of the switching.

An object of the present disclosure, which has been made in view of such circumstances, is to provide an in-vehicle device capable of improving smoothness of switching of communication lines.

An in-vehicle device according to an embodiment of the present disclosure includes a communication unit configured to perform communication via any mobile object communication line in a pair, and a controller configured to cause, in a case where a communication failure occurs during communication via a first line, the communication unit to switch to a second line and cause, in a case where the communication failure is resolved, the communication unit to switch from the second line to the first line. The controller is configured to cause, even in a case where the communication failure has been resolved, when an event in which communication via the second line is to be maintained occurs, the communication unit to maintain the communication via the second line until after a lapse of a predetermined period.

According to the embodiment of the present disclosure, it is possible to improve smoothness of switching of communication lines.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram showing a schematic configuration of a communication system according to an embodiment of the present disclosure; and

FIG. 2 is a flowchart showing an operation of the in-vehicle device.

### DETAILED DESCRIPTION OF EMBODIMENTS

An embodiment of the present disclosure will be described below.

### Overview of Embodiment

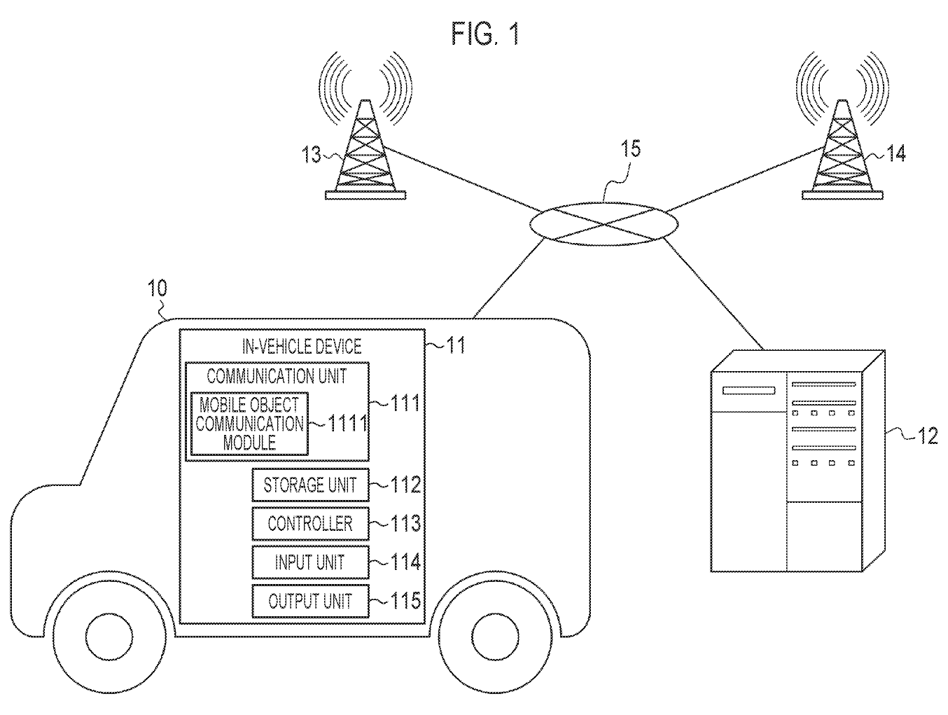

An overview of a communication system 1 according to the present disclosure will be described with reference to FIG. 1. The communication system 1 includes an in-vehicle device 11 mounted on a vehicle 10, and a server device 12. The vehicle 10 is, for example, a passenger car or a commercial car. The in-vehicle device 11 is, for example, an information processing apparatus that controls the vehicle, such as an electronic control unit (ECU). The server device 12 is, for example, a server computer that belongs to a cloud computing system or another computing system and that functions as a server implementing various functions. A network 15 is, for example, the Internet or a wide area communication network. The in-vehicle device 11 and the server device 12 are able to communicate with each other via the network 15. The number of the vehicles 10, the number of the in-vehicle devices 11, and the number of the server devices 12 shown in FIG. 1 may be optionally determined.

The in-vehicle device 11 has a wireless communication function of being connectable to the network 15 via the mobile object communication provided by a base station 13 or 14. The in-vehicle device 11 provides functions and services using information and communication technology (ICT) including an emergency call, autonomous driving, a navigation system, and the like to a user. The emergency call is to manually or automatically notify an emergency call reception institution of occurrence of a traffic accident or a transportation trouble in a case where the vehicle 10 encounters the traffic accident or the transportation trouble. In the emergency call, information including position information of the vehicle 10, a number of a telephone line, and the like is transmitted to the emergency call reception institution via the mobile object communication. The emergency call reception institutions the vehicle 10 using the number of the telephone line. The emergency call reception institution is, for example, a police force, a coast guard, or firefighting. The server device 12 is, for example, a server of a company that provides a service including an emergency call, a navigation system, and the like.

The base stations 13 and 14 are base stations of the mobile object communication provided by each of different mobile object communication providers. In some cases, it is difficult for the in-vehicle device to include a plurality of mobile object communication modules for connection to a plurality of lines at the same time due to constraints of manufacturing costs and circuit complexity. Therefore, for example, the in-vehicle device 11 according to the present embodiment is configured to be selectively connectable to any one of both lines provided by the base stations 13 and 14. Here, a mobile object communication line that is mainly used by the in-vehicle device 11 is referred to as a primary line, and a mobile object communication line that is used in a case where the primary line cannot be used due to a communication failure or the like is referred to as a secondary line. Specifically, the primary line is a line with a lighter cost burden for the user, such as a flat fee, and the secondary line is a line with a relatively heavier cost burden for the user, such as a usage-based fee, in accordance with a contract form with the mobile communication provider. In the present embodiment, for example, the mobile object communication line provided by the base station 13 is set as the primary line, and the mobile object communication line provided by the base station 14 is set as the secondary line. The number and types of the base stations 13 and 14 (that is, the types of the mobile object communication providers) shown in FIG. 1 may be optionally determined.

The in-vehicle device 11 according to the present embodiment includes a communication unit 111 and a controller 113. The communication unit 111 is configured to perform communication by any of a pair of mobile object communication lines. The controller 113 causes the communication unit 111 to switch to a second line (secondary line) in a case where a communication failure occurs during communication via a first line (primary line) and causes the communication unit 111 to switch from the secondary line to the primary line in a case where the communication failure is resolved. However, in a case where an event in which the communication via the secondary line is to be maintained (hereinafter, referred to as a maintenance event) occurs even in a case where the communication failure has been resolved, the controller 113 causes the communication unit 111 to maintain the communication via the secondary line until after a lapse of a predetermined period.

As described above, according to the present embodiment, it is possible to minimize use of the secondary line. In addition, it takes a certain amount of time to switch the lines. Therefore, there is a possibility that the user may feel inconvenience due to the uncertainty of the recovery from the failure in the primary line in addition to the interruption of the service provision caused by the disconnection of the communication during the switching. According to the present embodiment, it is possible to protect the user from such inconvenience. As a result, the smoothness of the switching of the communication lines is improved in terms of suppressing communication costs by minimizing the use of the secondary line and further protecting the user.

### Configuration of In-Vehicle Device

As shown in FIG. 1, the in-vehicle device 11 includes a storage unit 112, an input unit 114, and an output unit 115 in addition to the communication unit 111 and the controller 113.

The communication unit 111 includes a mobile object communication module 1111 corresponding to a mobile object communication standard such as long term evolution (LTE), 4th generation (4G), or 5th generation (5G), and a communication module corresponding to a wireless LAN standard. In the present embodiment, the communication unit 111 includes one mobile object communication module 1111. The mobile object communication module 1111 connects to any of the mobile object communication lines provided by the base stations 13 and 14. In the present embodiment, the in-vehicle device 11 is connected to the network 15 via the communication unit 111 and communicates with another terminal including the server device 12.

The storage unit 112 includes one or more memories. The memory is, for example, a semiconductor memory, a magnetic memory, or an optical memory. Each memory included in the storage unit 112 functions as, for example, a main memory, an auxiliary memory, or a cache memory. The storage unit 112 stores any information used in the operation of the in-vehicle device 11. For example, the storage unit 112 may store a system program, an application program, or embedded software. The information stored in the storage unit 112 may be capable of updating with information acquired from the network 15 via, for example, the communication unit 111.

The controller 113 includes one or more processors, one or more programmable circuits, one or more dedicated circuits, or a combination thereof. The processor is, for example, a general-purpose processor such as a central processing unit (CPU) or a graphics processing unit (GPU), or a dedicated processor specialized in specific processing. The programmable circuit is, for example, a field-programmable gate array (FPGA). The dedicated circuit is, for example, an application specific integrated circuit (ASIC). The controller 113 controls the operation of an entirety of the in-vehicle device 11 while each unit of the in-vehicle device 11 is controlled. In the present embodiment, the controller 113 determines a condition for switching the lines or the like and causes the communication unit 111 to switch the lines.

The input unit 114 includes one or more input devices that receive an operation by an operator. The input device is, for example, a physical key, a capacitive key, a capacitive panel, a touch screen integrally provided with a display, or a microphone that receives voice input. The input unit 114 receives an input of information used in the operation of the controller 113 and sends the input information to the controller 113. In the present embodiment, the emergency call may be received via the input unit 114.

The output unit 115 includes one or more output devices that output information. The output device is, for example, a display that outputs information in a video or a speaker that outputs information in a voice. The output unit 115 outputs information obtained by the operation of the controller 113.

### Operation Flow of In-Vehicle Device

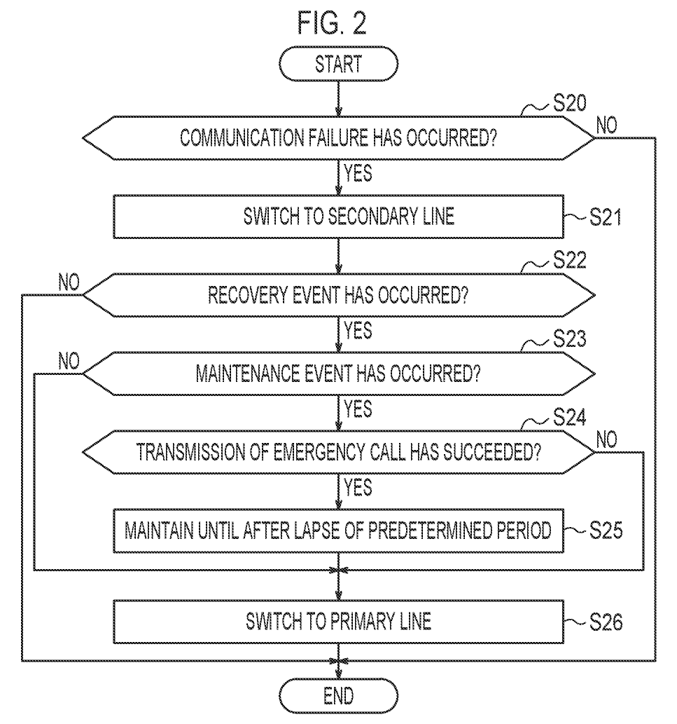

An operation executed by the controller 113 of the in-vehicle device 11 according to the present embodiment will be described with reference to FIG. 2. Each step in FIG. 2 is executed by the controller 113 at any cycle, for example, a cycle of several seconds to several minutes.

In S20, the controller 113 determines whether the communication failure occurs during the communication via the primary line. The occurrence of the communication failure is determined, for example, in a case where any one or both of disconnection of communication and delay of communication occur. In a case where the controller 113 determines that the communication failure occurs (S20-Yes), the controller 113 proceeds to S21. In a case where the controller 113 determines that the communication failure does not occur (S20-No), the controller 113 ends a cycle of one procedure in FIG. 2.

In S21, the controller 113 causes the communication unit 111 to switch from the primary line to the secondary line. The controller 113 instructs the communication unit 111 to switch to the secondary line, for example, and sets a connection destination of the mobile object communication module 1111 as the secondary line.

In S22, the controller 113 determines whether an event with a high probability of resolving the communication failure in the primary line (hereinafter, referred to as a recovery event) occurs. A condition for determining the occurrence of the recovery event is any one or both of that the controller 113 receives an instruction to switch from the secondary line to the primary line (hereinafter, referred to as a switching instruction) via the communication unit 111 and that a predetermined period elapses from the occurrence of the communication failure. The switching instruction is received from, for example, the server device 12. For example, in a case where the server device 12 receives notification of the resolution of the communication failure in the primary line from, for example, a mobile object communication provider of the primary line, the server device 12 sends the switching instruction to the in-vehicle device 11. In addition, the lapse of the predetermined period from the occurrence of the communication failure is a lapse of any time, for example, 1 to 5 hours from the occurrence of the communication failure. In a case where the controller 113 determines that the recovery event occurs (S22-Yes), the controller 113 proceeds to S23. In a case where the controller 113 determines that the recovery event does not occur (S22-No), the controller 113 ends the cycle of one procedure in FIG. 2.

In S23, the controller 113 determines whether an event in which the communication via the secondary line is to be maintained, that is, a maintenance event occurs. The occurrence of the maintenance event is determined in a case where any one or more of transmission of an emergency call, the use of a navigation system, and the use of an autonomous driving function occur. In a case where the lines are switched after the transmission of the emergency call is made, the number of the telephone line is changed. Therefore, a return phone contact cannot be received from the emergency call reception institution. In addition, since various types of information are acquired via the mobile object communication during the use of the navigation system and the autonomous driving function, it is required to avoid the interruption of the communication due to the switching of the lines from the viewpoint of traffic safety. As described above, by performing the determination of the occurrence of the maintenance event in addition to the determination of the occurrence of the recovery event, it is possible to protect the user from various dangers posed by the interruption of the service. In a case where the controller 113 determines that the maintenance event occurs (S23-Yes), the controller 113 proceeds to S24. In a case where the controller 113 determines that the maintenance event does not occur (S23-No), the controller 113 proceeds to S26.

In S24, the controller 113 determines whether the transmission of the emergency call is successful or unsuccessful during the transmission of the emergency call. The determination of the unsuccessful transmission of the emergency call is made, for example, in a case where there is no reply or return phone contact from the emergency call reception institution within a predetermined period. The predetermined period is, for example, any time such as 10 minutes to 20 minutes. In a case where the controller 113 determines that the transmission of the emergency call is successful, that is, that the transmission of the emergency call is not unsuccessful (S24-Yes), the controller 113 proceeds to S25. In a case where the controller 113 determines that the transmission of the emergency call is unsuccessful, that is, that the transmission of the emergency call is not successful (S24-No), the controller 113 proceeds to S26.

In S25, the controller 113 causes the communication unit 111 to maintain the communication via the secondary line until after a lapse of the predetermined period. The predetermined period is, for example, any time such as 30 minutes to 1 hour. Alternatively, the predetermined period is determined, for example, based on the maintenance event in S23. For example, in a case where the maintenance event is the transmission of the emergency call, the predetermined period is, for example, 30 minutes to 1 hour from the transmission of the emergency call. In a case where the maintenance event is the use of the navigation system or the autonomous driving function, the predetermined period is, for example, a required time to a destination. In a case where the predetermined period elapses, the controller 113 proceeds to S26.

In S26, the controller 113 causes the communication unit 111 to switch from the secondary line to the primary line. The controller 113 instructs the communication unit 111 to switch to the primary line and sets a connection destination of the mobile object communication module 1111 as the primary line.

In a modification S24 may be omitted in the operation.

In a further modification, in S22, the controller 113 may determine whether an accessory power supply of the vehicle 10 is activated or stopped. In a case where the controller 113 determines that any one or both of the occurrence of the recovery event and the activation or stop of the accessory power supply occur, the controller 113 proceeds to S23. In a case where the controller 113 determines that neither the occurrence of the recovery event nor the activation or stop of the accessory power supply occurs, the controller 113 ends the cycle of one procedure in FIG. 2.

In another modification, the switching to the primary line in S26 may be performed such that the switching is distributed for each vehicle. In S22, the controller 113 receives, for example, a switching timing randomly determined by the server device together with the switching instruction from the server device 12. Alternatively, the predetermined period from the occurrence of the communication failure in S22 is randomly determined, for example, by dividing a predetermined time into intervals (for example, 15 minutes) (any one of 3 hours, 3 hours and 15 minutes, or 3 hours and 30 minutes, or the like). Thereby, it is possible to avoid a failure occurring again in the primary line due to the occurrence of congestion caused by the switching of connections of a large number of vehicles to the primary line at substantially the same time.

The controller 113 may determine whether communication via the primary line is possible after the connection is switched to the primary line and may return the connection to the secondary line in a case where determination is made that the communication via the primary line is not possible. Determination is made that the communication via the primary line is not possible, for example, in a case where any one or both of the disconnection of the line and the delay of the communication occur.

Although the present disclosure has been described with reference to drawings and embodiments, it should be noted that various variations and modifications may be made by a person skilled in the art based on the present disclosure. Therefore, it should be noted that the variations and modifications fall within the scope of the present disclosure. For example, functions included in each component, each step, or the like can be rearranged not to be logically inconsistent, and multiple components, steps, or the like can be combined to one or separated.

In addition, for example, a general-purpose computer can also be used as the in-vehicle device 11 according to the embodiment. Specifically, a program describing processing contents that realize each function of the in-vehicle device 11 according to the embodiment is stored in a memory of the general-purpose computer, and the program is read and executed by a processor. Therefore, the present disclosure can also be realized as a program that can be executed by a processor or a non-transitory computer-readable medium that stores the program.

What is claimed is:

1. An in-vehicle device comprising:
a communication unit configured to perform communication via any mobile object communication line in a pair; and
a controller configured to cause, in a case where a communication failure occurs during communication via a first line, the communication unit to switch to a second line and cause, in a case where the communication failure is resolved, the communication unit to switch from the second line to the first line,
wherein the controller is configured to cause, even in a case where determination is made that the communication failure has been resolved in accordance with fulfillment of a predetermined condition, the communication unit to maintain communication via the second line until after a lapse of a predetermined period, based on determination of an event in which communication via the second line is to be maintained.

2. An in-vehicle device comprising:
a communication unit configured to perform communication via any mobile object communication line in a pair; and
a controller configured to cause, in a case where a communication failure occurs during communication via a first line, the communication unit to switch to a second line and cause, in a case where the communication failure is resolved, the communication unit to switch from the second line to the first line,
wherein the controller is configured to cause, even in a case where the communication failure has been resolved, when an event in which communication via the second line is to be maintained occurs, the communication unit to maintain the communication via the second line until after a lapse of a predetermined period.

3. The in-vehicle device according to claim 2, wherein the controller is configured to determine that the communication failure is resolved under a condition of any one or both of reception of an instruction to switch from the second line to the first line and the lapse of the predetermined period from occurrence of the communication failure.

4. The in-vehicle device according to claim 2, wherein the event is any one or both of transmission of an emergency call and use of a navigation system.

5. The in-vehicle device according to claim 4, wherein the controller is configured to cause, in a case where the transmission of the emergency call fails during the transmission of the emergency call, the communication unit to switch from the second line to the first line even when the event has occurred.
